(19) United States
(12) Patent Application Publication
(10) Pub. No.: US 2010/0139942 A1
(43) Pub. Date: Jun. 10, 2010

(54) ELECTRICAL CONDUIT OUTLET BODIES

(76) Inventor: Jeffrey Elwood, Catoosa, OK (US)

Correspondence Address: The BOC Group, Inc., 575 MOUNTAIN AVENUE, MURRAY HILL, NJ, 07974-2082, US

(21) Appl. No.: 12/331,726

(22) Filed: Dec. 10, 2008

(51) Int. Cl. H02G 3/04

(52) U.S. Cl. 174/68.3

(57) ABSTRACT

An improved electrical conduit outlet body having a tubular member which contains at least two apertures and at least one hole. The hole will allow for the removal of water from the electrical conduit and will reduce the cost and labor in providing wiring by eliminating external traps and drains.

### BACKGROUND OF THE INVENTION

The present invention provides for an improved electrical conduit outlet body. Electrical wiring is usually provided in bundles which may be a bundle of single conductors where each conductor is covered with its own dielectric barrier. An additional insulating layer such as polytetrafluoroethylene (PTFE) shrink tubing may be added over the bundles.

Conduits provide the means by which wires or bundles of wires are secured to the facility where the electrical wiring is to be installed. Typically the conduits are provided in various sizes and can be straight or have bends depending upon the type of installation. The electrical conduit thus serves to hold and to protect the wiring run through it.

The electrical conduits can be made of metal such as galvanized steel pipe, or made from plastic pipe. Electrical conduits are generally divided into four classes: thin-wall metal conduit, rigid threaded conduit, plastic conduit and flexible metal conduit. These conduits can come in different lengths and can be employed in any installation as long as they are employed in compliance with local, state and/or national codes.

The electrical conduits will typically terminate with a piece that must provide for drainage of water. For example, the 2008 National Electrical Code states in Article 225.22 that raceways on exteriors of buildings or other structures shall be arranged to drain and shall be rain tight in wet locations. Further in Article 230.53, this Code states that raceways enclosing service-entrance conductors shall be suitable for use in wet locations and arranged to drain. Raceways embedded in masonry shall be arranged to drain as well. Article 501.15(f) also addresses requirements that raceway systems have appropriate water removal means. Water can accumulate through condensation in the electrical conduit due to the factors of temperature change during the course of day and heating and cooling of the electrical wires inside the electrical conduit. This water must be removed in some fashion or it can cause problems such as shorting of the electrical wires or rusting and corrosion of the electrical conduit itself. Typically the electrical conduit termination will have an opening in the conduit which is generally threaded and to which a trap or drain is attached. This will allow for egress of moisture and prevent the problems associated with water accumulating in the electrical conduit.

While these are necessary solutions to the build up of water, they also add cost and time to the job of installing electrical wires and add further complexity to the wiring job. The present inventor has discovered a solution to the problem of water build-up that does not require the use of additional connections, traps and drains.

### SUMMARY OF THE INVENTION

The present invention provides for an improved electrical conduit outlet body comprising a tubular member having at least two apertures, the improvement comprising at least one hole being present in the tubular member.

The tubular member must have a diameter sufficient to allow the passage of electrical wires there through. This “fill” is also dictated by the National Electrical code as to the percentage of circular area you can fill with wiring and still maintain enough air circulation for cooling of the wires (typically about 40%).The tubular member consists of an interior wall surface and an exterior wall surface. The thickness of the tubular member will vary according to local and national building codes but is typically in the range of about 3/16 inch to about ⅜ inch.

The tubular member may be made of any material that is suitable for electrical conduits and approved. Typically this is based on national or local building codes and the electrical conduits are made of metal or plastic. Preferred electrical conduit materials are selected from those approved by NEC and AHJ ((National Electrical Code (“NEC”) and Authority Having Jurisdiction (“AHJ”)) as well as those from nationally recognized listing agencies such as Underwriters Laboratories. Electrical conduits are commercially available from Cooper/Crouse-Hinds, Appleton and Killark.

At least two apertures are installed in the tubular member to allow the tubular member to be attached to different varieties of electrical conduits. These apertures are sized to be roughly the same diameter as the tubular member and comprise a flange which may be threaded or not. At least two apertures are typical and three, four or five may be on the ends of the tubular member or intersecting the tubular member at some point between the two ends. In the instance of two apertures, the tubular member will be closed at one end, generally opposite from where the aperture is present, forming a front wall that is situated above one aperture.

The at least one hole present in the tubular member may be any opening that is sized to allow for the egress of moisture and penetrates both the inner wall and outer wall of the tubular member. The at least one hole may be present at any of four locations depending upon the configuration of the tubular member and the number of apertures present in the tubular member These holes may be present on the top portion of the tubular member or on the bottom portion of the tubular member. The at least one hole may also be present in the closed end of the tubular member, as well as the side walls of the tubular member.

Alternatively, if the tubular member is cast, a knockout may be present on each surface and the end user can knockout whichever side is needed for drainage.

### BRIEF DESCRIPTION OF THE DRAWINGS

FIG. 1 is an open top view schematic of an electrical conduit outlet body according to the present invention.

FIG. 2 is a side view schematic of an electrical conduit outlet body according to the present invention.

FIG. 3 is a top view schematic of an electrical conduit outlet body showing an alternative punch out for the holes depicted in FIGS. 1 and 2.

### DETAILED DESCRIPTION OF THE INVENTION

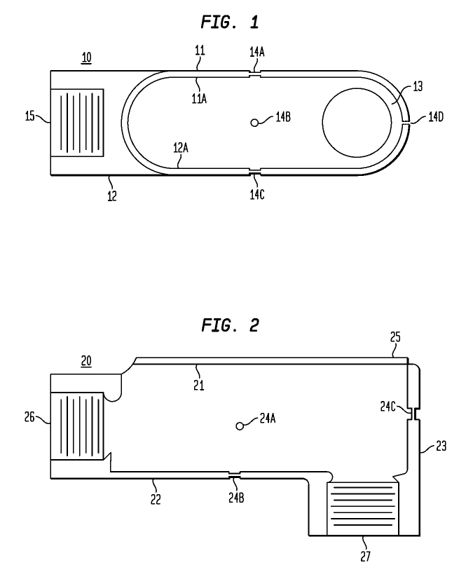

Turning to the figures, FIG. 1 is a top view schematic of the electrical conduit of the present invention. Tubular member 10 which can be made from a metal such as galvanized steel or plastic is shown with the cover removed. First side wall 11 and second side wall 12 define the outer walls of the tubular member and first inner wall 11A and second inner wall 12A define the inside dimensions of the tubular member. The diameter of the tubular member 10 must be sufficient to allow the appropriate wiring to pass through the tubular member 10. This diameter is defined by local and national building codes and can range from about ½ inch to about 6 inches. The thickness of the wall between 11 and 11A and 12 and 12A can be in the range of about 3/16 inch to about ⅜ inch with 0.200″ typical.

For purposes of the present invention the tubular member can be any conventional shape such as circular, square, rectangular, triangular, oval and can be either straight or containing bends along its length.

The open end aperture 15 of the tubular member hosts a flange which is threaded so that the electrical conduit can connect with other components of the electrical wiring scheme. Likewise at the opposite end of the tubular member there is an aperture 13 hosting a threaded flange which is situated below the outer walls 11 and 12. The positions of the holes that can be made in the tubular member are indicated by 14A, 14B, 14C and 14D. The number of holes that can be employed can be as few as one but can range upwards to any number that provides the appropriate moisture removal and taking into account the placement and positioning of the electrical conduit. As indicated in FIG. 1, a hole may be placed in either of the two side walls 11 and 12 of the tubular member 10 or the hole can be placed at the front end of the tubular member as noted at position 14D. Alternatively or with one or more of the other holes, a hole 14B can be made in the bottom portion of the tubular member.

FIG. 2 depicts the electrical conduit from its side. This is a typical configuration for the electrical conduit which allows for the electrical wires to make a 90 degree angle to a further electrical railway. The tubular member 20 has a removal cover piece 25 which is situated above the top wall 21 of the tubular member 10. The bottom wall 22 of tubular member 10 defines the diameter of the tubular member. As noted for FIG. 1, the thickness of the walls can be in the range of about 3/16 inch to about ⅜ inch with 0.200″ typical. The inside diameter of the tubular member 20 must be sufficient to allow the appropriate electrical wiring to pass through the tubular member 20. This diameter is defined by local and national building codes and can range from about ½ inch to about 6 inches.

The aperture 26 hosts a threaded flange which will allow this electrical conduit to be connected to other devices in the electrical wiring scheme. The front wall 23 of the tubular member 20 is situated above a second aperture 27 which hosts a threaded flange as well.

The one or more holes that can be employed in this electrical conduit are depicted by the designations 24A, 24B and 24C. 24A is actually a representation of two holes which can be present in either of the side walls of the tubular member 20. Hole 24B is positioned in the bottom of the tubular member 20 relative to the cover 25. Hole 24C is positioned in the front wall 23 of the tubular member. As indicated in the discussion of FIG. 1, the at least one hole may be two or more holes depending upon the moisture removal needs of the installer of the electrical wiring and electrical conduit.

The holes can be fashioned in any suitable manner. They may be drilled through the walls of the tubular member or made by punching a hole in the tubular member. The holes may also be made after the electrical conduit has been made or may be created when the electrical conduit is originally formed.

The hole may be any size to allow moisture to leave the tubular member while not damaging the structural integrity of the electrical conduit. Typically up to 3/16 of an inch is preferred.

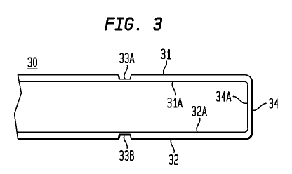

FIG. 3 shows a top view of a electrical conduit outlet body 30 according to the present invention. Outer side walls are shown as 31 and 32 being generally parallel to each other and being of a thickness of about 3/16 inch to about ⅜ inch to the inner walls 31A and 32A respectively. Outer end wall 34 and inner end wall 34A are of the same thickness. The holes are not fully formed and are shown as punch outs 33A and 33B and are roughly trapezoidal shaped. The end user can utilize a punch or other instrument to punch through the punch out. This will create a hole in the electrical conduit body specifically for the electrical wiring installation utilizing the electrical conduit outlet body.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, what I claim is:

1. An improved electrical conduit outlet body comprising a tubular member having at least one aperture, the improvement comprising at least one hole being present in said tubular member.

2. The electrical conduit outlet body as claimed in claim 1 wherein said tubular member comprises an inner wall surface and an exterior wall surface.

3. The electrical conduit outlet body as claimed in claim 1 wherein the diameter of said tubular member is sufficient to allow electrical wires to pass through said tubular member.

4. The electrical conduit outlet body as claimed in claim 1 wherein said tubular member is made from a material selected from the group consisting of metal and plastic.

5. The electrical conduit outlet body as claimed in claim 1 wherein there are two apertures in said tubular member.

6. The electrical conduit outlet body as claimed in claim 1 wherein said at least one aperture is threaded.

7. The electrical conduit outlet body as claimed in claim 1 wherein there are two holes in said tubular member.

8. The electrical conduit outlet body as claimed in claim 1 further comprising electrical wires passing through said tubular member.

9. The electrical conduit outlet body as claimed in claim 1 wherein said tubular member is in a shape selected from the group consisting of round, oval, triangular, square and rectangular.

10. The electrical conduit outlet body as claimed in claim 1 wherein said tubular member is straight.

11. The electrical conduit outlet body as claimed in claim 1 wherein said tubular member has one or more bends in it.

12. The electrical conduit outlet body as claimed in claim 1 wherein said at least one hole has a diameter of about ⅛ inch to about 3/16 inch.
